(19) United States
(12) Patent Application Publication
(10) Pub. No.: US 2024/0248993 A1
(43) Pub. Date: Jul. 25, 2024

(54) DATA PROTECTION METHOD, DATA PROTECTION SYSTEM AND MEMORY CHIP CAPABLE OF PROTECTING DATA WITH PHYSICAL STRUCTURE AND DATA PROTECTION FLOW

(71) Applicant: iMQ Technology Inc., Hsinchu City (TW)

(72) Inventor: Shih-Chen Peng, New Taipei City (TW)

(73) Assignee: iMQ Technology Inc., HSINCHU CITY (TW)

(21) Appl. No.: 18/098,717

(22) Filed: Jan. 19, 2023

(51) Int. Cl. G06F 21/57; G06F 21/56; G06F 21/75; H04L 9/06; H04L 9/14

(52) U.S. Cl. CPC G06F 21/575; G06F 21/566; G06F 21/755; H04L 9/0631; H04L 9/14; G06F 2221/034

(57) ABSTRACT

A data protection method is provided. The method includes resetting a system, performing a security boot operation to check whether a malware is installed in the system, inputting a first key to access initial data, storing the initial data to a volatile memory of the system, and running a predetermined program in the system with the initial data.

### BACKGROUND OF THE INVENTION

### 1. Field of the Invention

The disclosure is related to a data protection method, a data protection system and a memory chip capable of protecting data through a physical structure and a data protection flow.

### 2. Description of the Prior Art

In the field of memory devices, data protection is a challenge. In a conventional architecture, a processor can be used to access data in a memory for executing programs. However, the data in the memory may be easily stolen.

An illegal intruder (e.g. hacker) can obtain data in the memory by heating the memory, applying voltage to the memory, and/or applying electric pulses to the memory. As a result, the memory may be corrupted and the data may be read. In addition, the data in the memory can be read using probes if the package of the memory is opened or removed (a.k.a. decapped).

Alternatively, after the data in the memory is sent to the processor, the data in the memory space of the processor may be read by the hacker. Hence, a solution is still in need to improve data security.

### SUMMARY OF THE INVENTION

An embodiment provides a data protection method. The method includes resetting a system, performing a security boot operation to check whether a malware is installed in the system, inputting a first key to access initial data, storing the initial data to a volatile memory of the system, and running a predetermined program in the system with the initial data.

Another embodiment provides a data protection system including a memory chip and a controller. The memory chip is used to store initial data and a protection code. The controller is coupled to the memory chip and used to reset the system, perform a security boot operation to check whether a malware is installed in the controller, receive a first key to access the initial data from the memory chip, store the initial data to a volatile memory of the controller, and run a predetermined program with the initial data.

Another embodiment provides a memory chip including a memory and a processing unit. The memory is used to store initial data and a protection code. The processing unit is used to encrypt the initial data and the protection code. The initial data and the protection code are randomly arranged in the memory and indicated by pointers after being inputted to the memory.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 illustrates a data protection system according to an embodiment.

FIG. 2 is a flowchart of a data protection method with the data protection system in FIG. 1.

FIG. 3 to FIG. 6 illustrate structures of the memory chip according to different embodiments.

### DETAILED DESCRIPTION

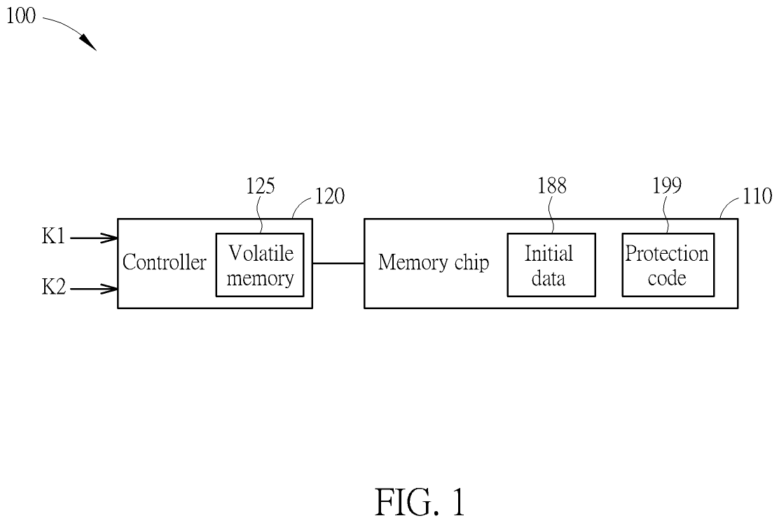

FIG. 1 illustrates a data protection system 100 according to an embodiment. The data protection system 100 can include a memory chip 110 and a controller 120. The memory chip 110 can be used to store initial data 188 and a protection code 199. The controller 120 can be coupled to the memory chip 110 and used to reset the system 100, perform a security boot operation to check whether a malware is installed in the controller 120, receive a first key K1 to access the initial data 188 from the memory chip 110, store the initial data 188 to a volatile memory 125 of the controller 120, and run a predetermined program with the initial data 188.

For example, the memory chip 110 can include a non-volatile memory such as a flash memory. The controller 120 can include a microcontroller unit (MCU). The volatile memory 125 can include a static random access memory (SRAM). However, embodiments are not limited thereto.

The controller 110 can be further used receive a second key K2 for accessing the protection code 199 in the memory chip 110. If the second key K2 can pass verification, the controller 120 can store the protection code 199 to the volatile memory 125. Then, the controller 120 can run a protection program in the controller 120 with the protection code 199 in the volatile memory 125. While running the protection program, the controller 120 can delete a used portion of the protection program because the volatile memory 125 can support reading and deleting at the same time.

By using the first key K1 and the second key K2, the difficulty of hacking data is increased. Since the volatile memory 125 can be read and erased concurrently, so the protection program can be run and deleted concurrently, the difficulty of hacking data from the controller 120 is further increased.

The first key K1 can be different from the second key K2 to increase the security. In another example, the first key K1 can be the same as the second key K2 for convenience, and the user can select the first key K1 and the second key K2 according to requirements.

In another scenario, the controller 110 can be further used to receive a second key K2 for accessing the protection code 199 in the memory chip 110. However, if the second key K2 fails verification, the controller 110 can store a false code to the volatile memory 125. Then, the controller 110 can run the protection program in the controller 120 with the false code in the volatile memory 125, and the controller 110 can delete a used portion of the protection program while still running the protection program. In this scenario, since the second key K2 fails verification (e.g. the second key K2 is incorrect), the result of running the protection program will be incorrect. Hence, the data can be secured because the hacker is misled to believe that the second key K2 is a valid key.

In addition, since the protection program can be run no matter the second key passes or fails verification, a hacker cannot try a plurality of keys through trial-and-error. In a conventional structure, once the used key is incorrect, the controller 110 would stop running the program, so a hacker may try a plurality of keys through trial-and-error. In the data protection system 100, it is unlikely to crack the system through trial-and-error.

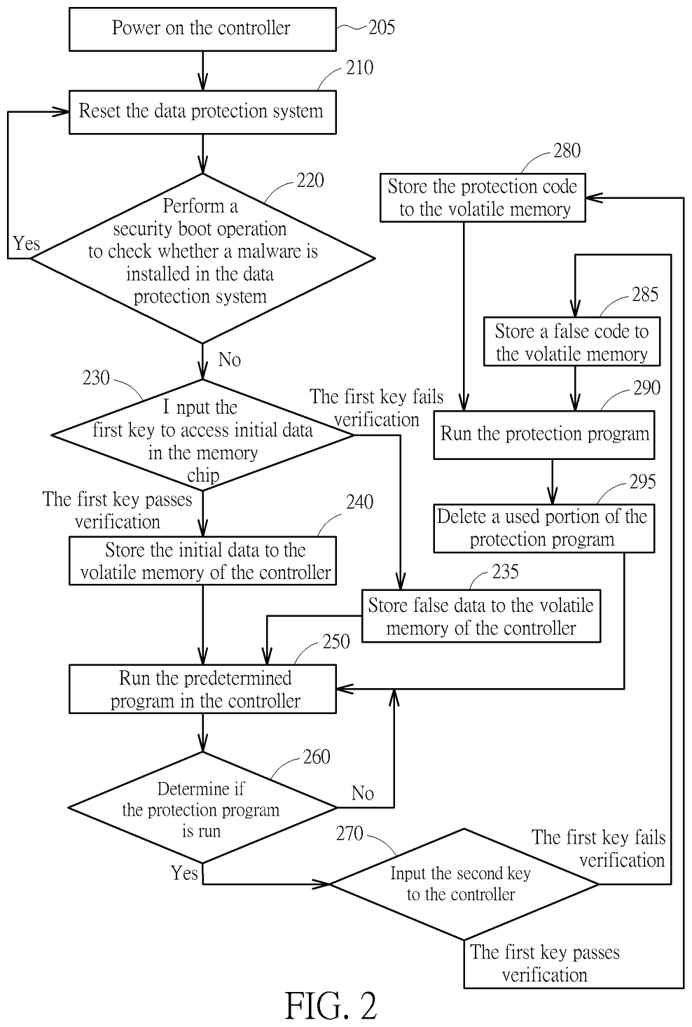

FIG. 2 is a flowchart of a data protection method 200 with the data protection system 100 in FIG. 1. As shown in FIG. 2, the following steps can be performed.

Step 205: power on the controller 120;

Step 210: reset the data protection system 100;

Step 220: perform a security boot operation to check whether a malware is installed in the data protection system 100; if so, enter Step 210; else, enter Step 230;

Step 230: input the first key K1 to access initial data 188 in the memory chip 110; if the first key K1 passes verification, enter Step 240; else, enter Step 235;

Step 235: store false data to the volatile memory 125 of the controller 120; enter Step 250;

Step 240: store the initial data 188 to the volatile memory 125 of the controller 120;

Step 250: run the predetermined program in the controller 120;

Step 260: determine if the protection program is run; if so, enter Step 270; else, enter Step 250;

Step 270: input the second key K2 to the controller 120; if the second key K2 passes verification, enter Step 280; else, enter Step 285;

Step 280: store the protection code 199 to the volatile memory 125; enter Step 290;

Step 285: store a false code to the volatile memory 125;

Step 290: run the protection program; and

Step 295: delete a used portion of the protection program.

In Step 210, the function and I/O (input/output) pins of the controller 120 can be reset; for example, general-purpose input/output (GPIO) pins of the controller 120 can be reset. In Step 220, if it is detected that a malware (e.g. Trojan horse virus) has been installed, the flow can enter Step 210 to reset the system again.

In Step 230, the first key K1 is received and verified. If the first key K1 passes verification, the flow can enter Steps 240 and 250 to correctly run the predetermined program. For example, the predetermined program can be a user's program such as a main program with a main loop. The initial data 188 can include initial values and default settings needed for running the predetermined program.

If the first key K1 fails verification, the flow can enter Steps 235 and 250 to incorrectly run the predetermined program. Hence, the predetermined program can still be run, however, the result will be incorrect. Hence, it is difficult to crack the data protection system 100 through trial-and-error since the process of running the predetermined program will continue as if the first key K1 has passed verification.

In Step 260, if it is determined to run the protection program, the second key K2 is required, and the flow can enter Step 270. If it is determined not to run the protection program, the flow can enter Step 250 to continue to run the predetermined program till it is completed.

In Step 270 to Step 290, like Step 230 to Step 250, if the second key K2 passes the verification, the correct protection code 199 can be stored to the volatile memory 125, and the protection program can be correctly run with the protection code 199 in Step 290.

If the second key K2 fails the verification, the false code can be stored to the volatile memory 125 in Step 285, and the protection program can be incorrectly run with the false code in Step 290. Hence, it is difficult to crack the data protection system 100 through trial-and-error since the process of running the protection program will not stop.

In Steps 290 and 295, since the volatile memory 125 can be read and erased concurrently, so the protection program can be run and deleted concurrently, and the difficulty of hacking data from the controller 120 is further increased.

After Step 295, the flow can selectively enter Step 250 to run the predetermined program (e.g. main program) till it is finished. Likewise, since the volatile memory 125 can be read and erased concurrently, so a used portion of the predetermined program can be deleted while running the predetermined program, and the difficulty of hacking data from the controller 120 is further increased.

In FIG. 1 and FIG. 2, each of the first key K1 and the second key K2 can include advanced encryption standard (AES) 128-bit key information, AES 256-bit key information and/or AES 192-bit key information.

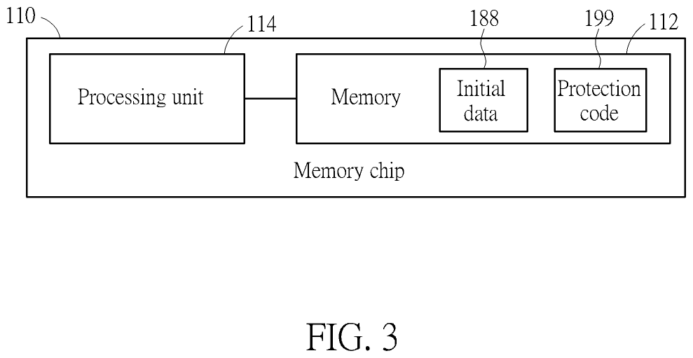

FIG. 3 illustrates a structure of the memory chip 110 according to an embodiment. The memory chip 110 can include a memory 112 and a processing unit 114. The memory 112 can be used to store data such as the initial data 188 and the protection code 199. The processing unit 114 can be used to encrypt the data stored in the memory 112. For example, the data can be encrypted with a predetermined calculation. The data can be randomly arranged in the memory 112 and indicated by pointers after inputting to the memory 112. Afterward, the pointers can be used by the controller 120 to read the data from the memory chip 110.

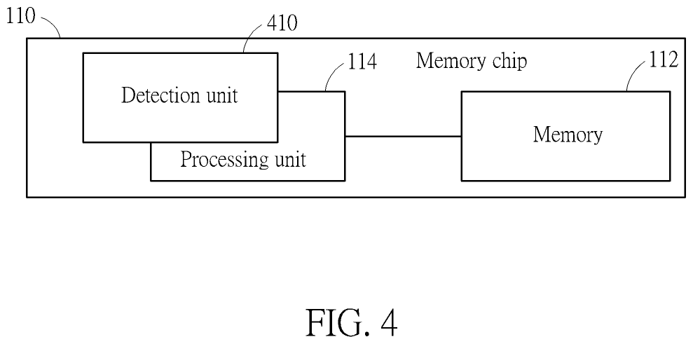

FIG. 4 illustrates a structure of the memory chip 110 according to another embodiment. In FIG. 4, the memory chip 110 can further include a detection unit 410. The detection unit 410 can include a temperature detector, a voltage detector and/or a pulse detector.

The temperature detector in the detection unit 410 can be used to detect an operation temperature. The processing unit 114 can delete or lock the data in the memory 112 if the operation temperature exceeds a threshold.

The voltage detector in the detection unit 410 can be used detect an applied voltage. The processing unit 114 can delete or lock the data in the memory 112 if the applied voltage exceeds a threshold.

The pulse detector in the detection unit 410 can be used to detect an applied pulse. The processing unit 114 can delete or lock the data in the memory 112 if a voltage level of the applied pulse exceeds a threshold voltage and/or a duration of the applied pulse exceeds a threshold period.

Here, when the data in the memory 112 is locked, it means the processing unit 114 can run a security program to prevent the data in the memory 112 from being read even if correct keys are inputted. A more complicated process with a higher security level can be performed for unlocking the data afterward.

As a result, if a hacker applies heat, voltage or electric pulse for cracking the memory chip 110, the data can be locked or even deleted, so the data is secured.

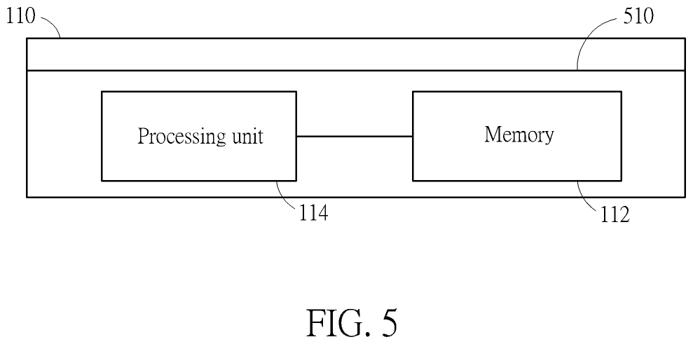

FIG. 5 illustrates a structure of the memory chip 110 according to another embodiment. In FIG. 5, the memory chip 110 can further include a conductive layer 510. The conductive layer 510 can be used to destroy the memory 112 if a package of the memory chip 110 is intruded. For example, it the package of the memory chip 110 is opened, broken or cut (a.k.a. “decapped”), the conductive layer 510 can be heated to melt, and the generated liquid metal can flow to the memory 112 to destroy the memory 112 and the data in the memory 112. In another scenario, if heat, voltage and/or electric pulse is abnormally applied to the memory chip 110, the conductive layer 510 can melt to destroy the memory 112 and the data in the memory 112. For example, the conductive layer 510 can have a mesh structure to be melted easily.

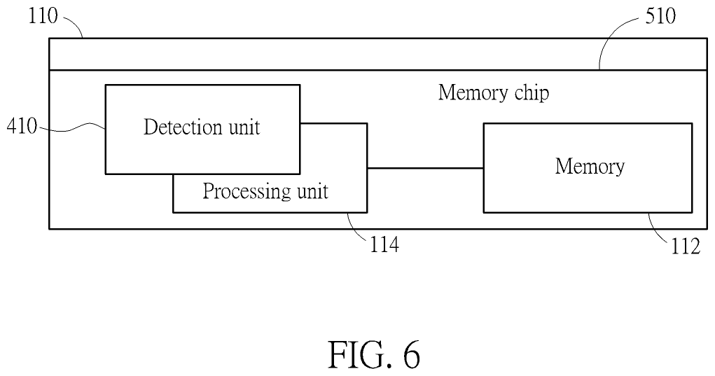

FIG. 6 illustrates a structure of the memory chip 110 according to another embodiment. In FIG. 6, the memory chip 110 can include the detection unit 410 and the conductive layer 510. The similarities among FIG. 4, FIG. 5 and FIG. 6 are not repeatedly described.

In summary, physical mechanisms and processing flow are provided by embodiments, hence an improved solution is provided to secure the data in the memory chip 110. Through the data protection system 100, the data protection method 200 and the memory chip 110, the difficulty of cracking a memory and hacking the data in the memory is increased. The security of data in the memory is effectively improved.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A data protection method comprising:
resetting a system;
performing a security boot operation to check whether a malware is installed in the system;
inputting a first key to access initial data;
storing the initial data to a volatile memory of the system; and
running a predetermined program in the system with the initial data.

2. The method of claim 1, further comprising:
inputting a second key to the system;
if the second key passes verification, storing a protection code to the volatile memory;
running a protection program with the protection code in the system; and
deleting a used portion of the protection program.

3. The method of claim 2, wherein the first key is different from the second key.

4. The method of claim 2, wherein the second key comprises advanced encryption standard (AES) 128-bit key information, AES 256-bit key information and/or AES 192-bit key information.

5. The method of claim 1, further comprising:
inputting a second key to the system;
if the second key fails verification, storing a false code to the volatile memory;
running a protection program with the false code in the system; and
deleting a used portion of the protection program.

6. The method of claim 4, wherein the first key is different from the second key.

7. The method of claim 1, wherein the first key comprises advanced encryption standard (AES) 128-bit key information, AES 256-bit key information and/or AES 192-bit key information.

8. The method of claim 1, wherein the volatile memory is in a static random access memory (SRAM).

9. The method of claim 1, wherein if the malware is installed in the system, the system is reset again.

10. A data protection system comprising:
a memory chip configured to store initial data and a protection code; and
a controller coupled to the memory chip and configured to reset the system, perform a security boot operation to check whether a malware is installed in the controller, receive a first key to access the initial data from the memory chip, store the initial data to a volatile memory of the controller, and run a predetermined program with the initial data.

11. The system of claim 10, wherein the controller is further configured to:
receive a second key for accessing the protection code in the memory chip;
if the second key passes verification, store the protection code to the volatile memory;
run a protection program in the controller with the protection code in the volatile memory; and
delete a used portion of the protection program.

12. The method of claim 11, wherein the first key is different from the second key.

13. The method of claim 10, wherein the controller is further configured to:
receive a second key for accessing the protection code in the memory chip;
if the second key fails verification, store a false code to the volatile memory;
run a protection program in the controller with the false code in the volatile memory; and
deleting a used portion of the protection program.

14. The method of claim 13, wherein the first key is different from the second key.

15. A memory chip comprising:
a memory configured to store initial data and a protection code; and
a processing unit configured to encrypt the initial data and the protection code;
wherein the initial data and the protection code are randomly arranged in the memory and indicated by pointers after inputting to the memory.

16. The memory chip of claim 15, further comprising:
a temperature detector configured to detect an operation temperature;
wherein the processing unit is further configured to delete or lock the initial data and the protection code if the operation temperature exceeds a threshold.

17. The memory chip of claim 15, further comprising:
a voltage detector configured to detect an applied voltage;
wherein the processing unit is further configured to delete or lock the initial data and the protection code if the applied voltage exceeds a threshold.

18. The memory chip of claim 15, further comprising:
a pulse detector configured to detect an applied pulse;
wherein the processing unit is further configured to delete or lock the initial data and the protection code if a voltage level of the applied pulse exceeds a threshold voltage and/or a duration of the applied pulse exceeds a threshold period.

19. The memory chip of claim 15, further comprising:
a conductive layer configured to destroy the initial data and the protection code if a package of the memory chip is intruded.
